(19) United States
(12) Patent Application Publication
(10) Pub. No.: US 2025/0115717 A1
(43) Pub. Date: Apr. 10, 2025

(54) POLYETHERIMIDE COMPOSITION, METHOD FOR THE MANUFACTURE THEREOF, AND INJECTION MOLDED ARTICLES MADE THEREFROM

(71) Applicant: SHPP GLOBAL TECHNOLOGIES B.V., Bergen Op Zoom (NL)

(72) Inventors: Peter JOHNSON, Evansville, IN (US); Thomas Link GUGGENHEIM, Mt. Vernon, IN (US); Joshua McClellan CROLL, Evansville, IN (US); Adam J. WEISGERBER, Elberfeld, IN (US); Juan Justino Rodriguez ORDONEZ, Murcia (ES)

(21) Appl. No.: 18/836,041

(22) PCT Filed: Feb. 8, 2023
(86) PCT No.: PCT/IB2023/051135

§ 371 Date: Aug. 6, 2024

(30) Foreign Application Priority Data
Feb. 9, 2022 (EP) 22382107.5

(51) Int. Cl. C08G 73/10; C08K 3/013

(52) U.S. Cl. CPC C08G 73/1014; C08G 73/1053; C08K 3/013

(57) ABSTRACT

A polyetherimide composition includes a polyetherimide having a percent transmission of 75% to 85% at 500 nanometers as determined according to ASTM D1003 at a thickness of 1.6 mm. The composition further includes a colorant. A molded sample of the polyetherimide composition can have a percent transmission of greater than 40% at a thickness of 1.6 millimeters and a percent transmission of greater than 15% at a thickness of 3.2 millimeters, each at a wavelength of 450 nanometers and determined according to ASTM D 1003. Methods of the manufacture of the polyetherimide composition and injection molded articles prepared therefrom are also disclosed.

### CROSS REFERENCE TO RELATED APPLICATION

This application claims priority to and the benefit of European Patent Application No. 22382107.5, filed on Feb. 9, 2022, the contents of which are incorporated by reference herein in their entirety.

### BACKGROUND

Polyimides possess many desirable properties such as high heat resistance, flame retardance, dimensional stability, strength, chemical resistance, biocompatibility, high dielectric strength, and transparence. Correspondingly, polyetherimide is employed for the manufacture of a wide range of articles. Some of these applications include automotive applications (e.g., air intake manifolds, fluids handling, lighting applications, electrical connectors), medical applications (e.g., vascular infusion ports, luer connectors, stopcocks, dialysis filters), aerospace applications (e.g., interior semi-structural components, interior cladding, fluids handling, electrical connections), and electrical applications (e.g., electrical connectors, structural components). Furthermore, polyetherimide lends itself to most forms of thermoplastic processing and conversion, such as extrusion, injection molding, and the like. Although polyetherimides possess these, and other beneficial properties, it's utility can be hindered in some applications due to its amber color. This is especially the case in applications in which bright white, pale grey, pale blue, and pale green colors are desired. The utility of polyetherimides can further be hindered when transparency is needed. There have been some efforts to offset the amber color of polyetherimide using white pigments such as titanium dioxide, however this can diminish the transparency of the composition.

Accordingly, there remains a need in the art for transparent polyetherimides. It would be a further advantage to provide colored transparent polyetherimide compositions.

### SUMMARY

A polyetherimide composition comprises a polyetherimide having a percent transmission of 72% to 85% at a wavelength of 500 nanometers as determined according to ASTM D1003 at a thickness of 1.6 mm and comprising repeating units derived from bisphenol A dianhydride and an organic diamine; and a colorant; wherein a molded sample of the polyetherimide composition has a percent transmission of greater than 40% at a wavelength of 450 nanometers according to ASTM D1003 at a thickness of 1.6 millimeters; and a percent transmission of greater than 15% at a wavelength of 450 nanometers according to ASTM D1003 at a thickness of 3.2 millimeters.

A method for the manufacture of the polyetherimide composition comprises melt-mixing the components of the composition.

An injection molded article comprises the polyetherimide composition.

The above described and other features are exemplified by the following figure and detailed description.

### BRIEF DESCRIPTION OF THE DRAWINGS

The following figure represents an exemplary embodiment.

FIG. 1 shows a plot of transmission at a thickness of 1.6 millimeters versus wavelength (from 360 nanometers to 720 nanometers) for compositions according to example 3 and comparative examples 12 and 13.

### DETAILED DESCRIPTION

The present inventors have unexpectedly discovered a polyetherimide composition that can desirably provide colored, transparent articles. Specifically, the transparent polyetherimide can advantageously provide injection molded articles having a percent transmission of greater than 40% at a wavelength of 450 nanometers according to ASTM D1003 at a thickness of 1.6 millimeters and a percent transmission of greater than 15% at a wavelength of 450 nanometers according to ASTM D1003 at a thickness of 3.2 millimeters. In some aspects, overall transmission is increased, for example, such that an average percent transmission of the composition is 60% to 85% from 400 nanometers to 720 nanometers determined from transmission data collected according to ASTM D1003 at a thickness of 1.6 mm.

Accordingly, an aspect of the present disclosure is a polyetherimide composition. The polyetherimide composition comprises a polyetherimide comprising repeating units derived from bisphenol A and an organic diamine. The polyetherimide of the present disclosure comprises more than 1, for example 2 to 1000, or 5 to 500, or 10 to 100 structural units of formula (1)

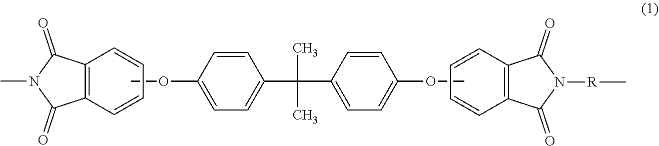

wherein each R is independently the same or different, and is a substituted or unsubstituted divalent organic group, such as a substituted or unsubstituted C₆₋₂₀ aromatic hydrocarbon group, a substituted or unsubstituted straight or branched chain C₄₋₂₀ alkylene group, a substituted or unsubstituted C₃₋₈ cycloalkylene group, in particular a halogenated derivative of any of the foregoing. In an aspect R is divalent group of one or more of the following formulas (2)

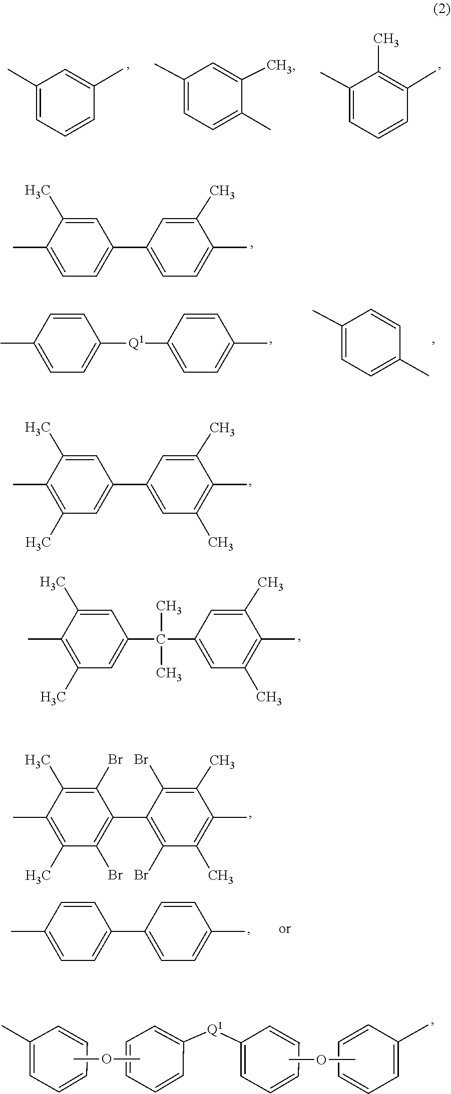

wherein Q¹ is —O—, —S—, —C(O)—, —SO₂—, —SO—, —P(R^{a})(═O)— wherein R^{a} is a C₁₋₈ alkyl or C₆₋₁₂ aryl, —C_{y}H_{2y}— wherein y is an integer from 1 to 5 or a halogenated derivative thereof (which includes perfluoroalkylene groups), or —(C₆H₁₀)_{z}— wherein z is an integer from 1 to 4. In an aspect R is m-phenylene, p-phenylene, or a diarylene sulfone, in particular bis(4,4′-phenylene)sulfone, bis(3,4′-phenylene)sulfone, bis(3,3′-phenylene)sulfone, or a combination comprising at least one of the foregoing. In an aspect, at least 10 mole percent or at least 50 mole percent of the R groups contain sulfone groups, and in other aspects no R groups contain sulfone groups. In an aspect in formula (1), R is m-phenylene, p-phenylene, or a combination comprising at least one of the foregoing. In an aspect, at least 50 mole percent, or at least 75 mole percent, or at least 90 mole percent of the R groups are derived from meta-phenylene diamine. Further in formula (1), the divalent bonds of the —O— of the bisphenol A group can be in the 3,3′, 3,4′, 4,3′, or the 4,4′ positions, preferably the 4,4′ positions. In an aspect, R can be m-phenylene and the divalent bonds of the —O— of the bisphenol A group can be in the 4,4′ positions. Such materials are available under the trade name ULTEM from SABIC. Alternatively, the polyetherimide can be a copolymer comprising additional structural polyetherimide units of formula (1) wherein at least 50 mole percent (mol %) of the R groups are bis(4,4′-phenylene)sulfone, bis(3,4′-phenylene)sulfone, bis(3,3′-phenylene)sulfone, or a combination comprising at least one of the foregoing and the remaining R groups are p-phenylene, m-phenylene or a combination comprising at least one of the foregoing; an example of which is commercially available under the trade name EXTEM from SABIC.

In an aspect, the polyetherimide is a copolymer that optionally comprises additional structural imide units that are not polyetherimide units, for example imide units of formula (3)

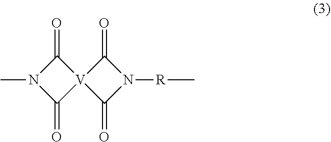

wherein R is as described in formula (1) and each V is the same or different, and is a substituted or unsubstituted C₆₋₂₀ aromatic hydrocarbon group, for example a tetravalent linker of the formulas

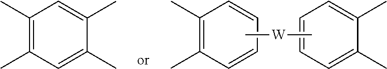

wherein W is a single bond, —O—, —S—, —C(O)—, —SO₂—, —SO—, a C₁₋₁₈ hydrocarbylene group, —P(R^{a})(═O)— wherein R^{a} is a C₁₋₈ alkyl or C₆₋₁₂ aryl, or —C_{y}H_{2y}— wherein y is an integer from 1 to 5 or a halogenated derivative thereof (which includes perfluoroalkylene groups). These additional structural imide units preferably comprise less than 20 mol % of the total number of units, and more preferably can be present in amounts of 0 mol % to 10 mol % of the total number of units, or 0 mol % to 5 mol % of the total number of units, or 0 mol % to 2 mol % of the total number of units. In an aspect, no additional imide units are present in the polyetherimide.

The polyetherimide can be prepared by any methods, including the reaction of an aromatic bis(ether anhydride) of formula (4) or a chemical equivalent thereof, with an organic diamine of formula (5)

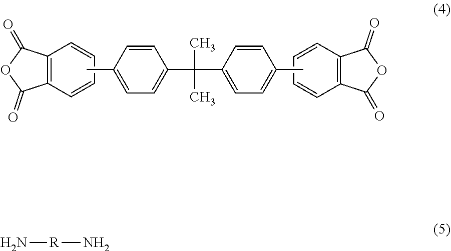

wherein R is defined as described above. Copolymers of the polyetherimides can be manufactured using a combination of an aromatic bis(ether anhydride) of formula (4) and an additional bis(anhydride) that is not a bis(ether anhydride), for example pyromellitic dianhydride or bis(3,4-dicarboxyphenyl) sulfone dianhydride.

Illustrative examples of aromatic bis(ether anhydride)s include 2,2-bis[4-(3,4-dicarboxyphenoxy)phenyl]propane dianhydride (also known as bisphenol A dianhydride or BPADA), 3,3-bis[4-(3,4-dicarboxyphenoxy)phenyl]propane dianhydride; and 4,4′-bis(3,4-dicarboxyphenoxy)diphenyl ether dianhydride. A combination of different aromatic bis(ether anhydride)s can be used.

A bisphenol A dianhydride particularly useful for the preparation of the polyetherimide of the present disclosure can be prepared for example, according to International Publication No. 2020/160215, incorporated herein by reference in its entirety. In an aspect, the bisphenol A dianhydride can be a bisphenol A dianhydride composition prepared and purified according to the procedures described in International Publication No. 2020/160215 and can advantageously comprise less than 25 ppm each of sodium ions, potassium ions, calcium ions, zinc ions, aluminum ions, titanium ions, iron ions, and phosphorus ions. For example, the purified bisphenol A dianhydride can comprise 1 ppm to less than 25 ppm each of sodium ions, potassium ions, calcium ions, zinc ions, aluminum ions, titanium ions, iron ions, and phosphorus ions The purified bisphenol A dianhydride can comprise less than 50 ppm each of phosphate ions, sulfate ions, chloride ions, nitrate ions, and nitrite ions. For example, the purified bisphenol A dianhydride can comprise 1 ppm to less than 50 ppm each of phosphate ions, sulfate ions, chloride ions, nitrate ions, and nitrite ions. In an aspect, particularly when the polyetherimide is prepared from a bisphenol A dianhydride composition prepared and purified according to the procedures described in International Publication No. 2020/160215, the polyetherimide can comprise less than 25 ppm each of sodium ions, potassium ions, calcium ions, zinc ions, aluminum ions, titanium ions, iron ions, and phosphorus ions and less than 25 ppm each of phosphate ions, sulfate ions, chloride ions, nitrate ions, and nitrite ions.

Examples of organic diamines include 1,4-butane diamine, 1,5-pentanediamine, 1,6-hexanediamine, 1,7-heptanediamine, 1,8-octanediamine, 1,9-nonanediamine, 1,10-decanediamine, 1,12-dodecanediamine, 1,18-octadecanediamine, 3-methylheptamethylenediamine, 4,4-dimethylheptamethylenediamine, 4-methylnonamethylenediamine, 5-methylnonamethylenediamine, 2,5-dimethylhexamethylenediamine, 2,5-dimethylheptamethylenediamine, 2,2-dimethylpropylenediamine, N-methyl-bis(3-aminopropyl)amine, 3-methoxyhexamethylenediamine, 1,2-bis(3-aminopropoxy) ethane, bis(3-aminopropyl) sulfide, 1,4-cyclohexanediamine, bis-(4-aminocyclohexyl) methane, m-phenylenediamine, p-phenylenediamine, 2,4-diaminotoluene, 2,6-diaminotoluene, m-xylylenediamine, p-xylylenediamine, 2-methyl-4,6-diethyl-1,3-phenylene-diamine, 5-methyl-4,6-diethyl-1,3-phenylene-diamine, benzidine, 3,3′-dimethylbenzidine, 3,3′-dimethoxybenzidine, 1,5-diaminonaphthalene, bis(4-aminophenyl) methane, bis(2-chloro-4-amino-3,5-diethylphenyl) methane, bis(4-aminophenyl) propane, 2,4-bis(p-amino-t-butyl) toluene, bis(p-amino-t-butylphenyl) ether, bis(p-methyl-o-aminophenyl)benzene, bis(p-methyl-o-aminopentyl)benzene, 1, 3-diamino-4-isopropylbenzene, bis(4-aminophenyl) sulfide, bis-(4-aminophenyl) sulfone (also known as 4,4′-diaminodiphenyl sulfone (DDS)), and bis(4-aminophenyl) ether.

Any regioisomer of the foregoing compounds can be used. C₁₋₄ alkylated or poly(C₁₋₄)alkylated derivatives of any of the foregoing can be used, for example a polymethylated 1,6-hexanediamine. Combinations of these compounds can also be used. In an aspect the organic diamine is m-phenylenediamine, p-phenylenediamine, 4,4′-diaminodiphenyl sulfone, 3,4′-diaminodiphenyl sulfone, 3,3′-diaminodiphenyl sulfone, or a combination comprising at least one of the foregoing. In an aspect, the organic diamine is m-phenylenediamine, p-phenylenediamine, or a combination thereof, preferably m-phenylene.

In an aspect, the polyetherimide can be free of fluorine substituents. For example, the polyetherimide can comprise less than 0.1 weight percent of fluorine substituents, based on the total weight of the polyetherimide. In an aspect, the polyetherimide can comprise greater than 0 ppm to 10 ppm of fluorine. Fluorine content in the polyetherimide structure can be determined using techniques such as X-ray fluorescence (XRF), ¹⁹F nuclear magnetic resonance (NMR) spectroscopy, inductively coupled plasma mass spectrometry (ICP-MS), or inductively coupled plasma optical emission spectroscopy (ICS-OES).

The polyetherimide can have a melt index of 0.1 grams per minute (g/min) to 10 g/min, as measured by American Society for Testing Materials (ASTM) D1238 at 330° C. to 370° C., for example at 337° C., using a 6.7 kilogram (kg) weight. In an aspect, the polyetherimide can have a weight average molecular weight (Mw) of 1,000 grams/mole to 150,000 grams/mole (g/mol or Dalton (Da)), as measured by gel permeation chromatography, using polystyrene standards. In an aspect the polyetherimide can have an Mw of 10,000 g/mol to 80,000 g/mol. Such polyetherimides typically have an intrinsic viscosity greater than 0.2 deciliters per gram (dl/g), or, more specifically, 0.35 dl/g to 0.7 dl/g as measured in m-cresol at 25° C.

The polyetherimide has a percent transmission of 72% to 85% at 500 nanometers as determined according to ASTM D1003 at a thickness of 1.6 mm. The polyetherimide can further have a percent transmission of 65% to 85% at 500 nanometers as determined according to ASTM D1003 at a thickness of 3.2 mm. In an aspect, the polyetherimide can have an average percent transmission of 72% to 85% over the range of 400 nm to 720 nm, as determined according to ASTM D1003 at a thickness of 1.6 mm. In an aspect, the polyetherimide can have an average percent transmission of 65% to 85% over the range of 400 nm to 720 nm, as determined according to ASTM D1003 at a thickness of 3.2 mm.

In addition to the polyetherimide, the polyetherimide composition further comprises a colorant. In an aspect, the colorant is preferably a non-white colorant. The colorant can be selected based on the desired color for the polyetherimide composition. In an aspect, the colorant comprises an organic pigment, an organic dye, or a combination thereof. The colorant is further selected such that the presence of the colorant does not increase the haze of a molded sample of the polyetherimide composition by more than 5 percent relative to the haze of a corresponding molded article of the polyetherimide composition not including the colorant. The colorant can be considered to be miscible or soluble in the polyetherimide when the presence of the colorant does not increase the haze of a molded sample of the polyetherimide composition by more than 5 percent relative to the haze of a corresponding molded article of the polyetherimide composition not including the colorant.

Suitable dye classes from which the colorant can be selected include anthraquinones, anthrapyridones, perylenes, anthracenes, perinones, indanthrones, quinacridones, xanthenes, thioxanthenes, oxazines, oxazolines, indigoids, thioindigoids, quinophthalones, naphthalimides, cyanines, methines, pyrazolones, lactones, coumarins, bis-benzoxazolylthiophenes, naphthalenetetracarboxylic acids, phthalocyanines, triarylmethanes, aminoketones, bis(styryl)biphenyls, azines, rhodamines, derivatives of the foregoing, and mixtures thereof. In an aspect, the colorant can comprise a violet dye, a red dye, or a combination thereof. In an aspect, the colorant can comprise a violet organic dye and a red organic dye. Other organic dyes can be possible, for example, a green organic dye, an orange organic dye, a blue organic dye, a purple organic dye, a yellow organic dye, or a combination of any of the foregoing. For example, the colorant can comprise a mixture comprising a green organic dye and a red organic dye, a mixture comprising an orange organic dye, blue organic dye, and red organic dye, a mixture comprising a purple organic dye, a yellow organic dye and a blue organic dye, and combinations thereof.

In an aspect, the colorant can comprise at least one dye combination selected from a solvent, disperse or vat red dye and a solvent or disperse green dye, a solvent or disperse violet dye and a solvent or disperse blue dye, a solvent, disperse or vat red dye and a solvent or disperse blue dye, a solvent or disperse yellow dye and a solvent or disperse blue, a solvent or disperse orange dye and solvent or disperse blue dye. The colorant can comprise at least two of the dye combinations, or at least three such dye combinations.

Specific organic dyes and organic pigments suitable for use as the colorant include Disperse Yellow 54, Disperse Yellow 201, Solvent Yellow 33, Solvent Yellow 63, Solvent Yellow 93, Solvent Yellow 98, Solvent Yellow 104, Solvent Yellow 114, Solvent yellow 160, Solvent Yellow 188, Pigment Yellow 110, Pigment Yellow 138, Pigment Yellow 147, Pigment Yellow 180, Pigment Yellow 183, Pigment Yellow 184 Solvent Green 3, Solvent Green 28, Pigment Green 7, Pigment Green 36, Solvent Red 52, Solvent Red 135, Solvent Red 149, Solvent Red 179, Solvent Red 207, Vat Red 41, Pigment Red 122, Pigment Red 149, Pigment Red 178, Pigment Red 181, Pigment Red 202, Pigment Red 254, Solvent Violet 13, Solvent Violet 36, Disperse Violet 26, Disperse Violet 31, Pigment Violet 19, Disperse Orange 47, Solvent Orange 60, Solvent Orange 63, Solvent Orange 60, Solvent Orange 63, Solvent Orange 64, Pigment Orange 71 and Solvent Blue 97, Solvent Blue 104, Pigment Blue 15, !5:1, 15:2 15:3 & 15:4, Pigment Blue 60. Other dyes and pigments are possible.

In an aspect, the colorant can include, but is not limited to Solvent Violet 13, Solvent Violet 36, Pigment Blue 15:4, Pigment Blue 29, Solvent Red 52, and the like, as well as combinations thereof. For example, a combination of Solvent Violet 13 and Solvent Red 52 and a combination of Solvent Violet 36 and Pigment Blue 15:4 are mentioned.

The polyetherimide composition can comprise the polyetherimide in an amount of 99.75 weight percent to 99.9995 weight percent, based on the total weight of the composition. Within this range, the polyetherimide can be present in the composition in an amount of 99.75 weight percent to 99.999 weight percent, or 99.9 weight percent to 99.999 weight percent, or 99.99 weight percent to 99.999 weight percent, or 99.99 weight percent to 99.997 weight percent, or 99.99 weight percent to 99.995 weight percent, each based on the total weight of the composition.

The amount of the colorant to be included in the composition can depend on the desired color and the specific colorant to be used. As already mentioned above, the colorant is selected such that the presence of the colorant does not increase the haze of a molded sample of the polyetherimide composition by more than 5 percent (i.e., the colorant is soluble in the polyetherimide). It will therefore be understood that an acceptable amount of the colorant can depend on the particular colorant to be used. Stated another way, some colorants can allow for achieving the desired transmission at higher loadings than other. For example, the transmission of the individual colorant can provide insight towards the desired loading into a polyetherimide composition. In general, a colorant which weakly absorbs light at a wavelength of interest can accommodate a higher loading in a composition compared to a colorant which strongly absorbs light at a wavelength of interest.

In general, the colorant can be present in an amount of 0.0005 weight percent to 0.25 weight percent, based on the total weight of the composition. Within this range, the colorant can be present in the composition in an amount of 0.001 weight percent to 0.25 weight percent, or 0.001 weight percent to 0.1 weight percent, or 0.001 weight percent to 0.01 weight percent, or 0.003 weight percent to 0.01 weight percent, or 0.005 weight percent to 0.01 weight percent, or 0.0005 weight percent to 0.05 weight percent, or 0.0005 weight percent to 0.01 weight percent, or 0.0015 weight percent to 0.05 weight percent, or 0.0015 weight percent to 0.01 weight percent, each based on the total weight of the composition.

In an aspect, the polyetherimide composition can comprise the polyetherimide having repeating units according to formula (1), wherein at least 50 mole percent of the R groups are derived from meta-phenylene diamine, and the colorant comprising at least two solvent dyes, at least two pigments, or a combination of at least one solvent dye and at least one pigment. In an aspect, a molded sample of the composition can exhibit an average percent transmission of 60% to 75% from 400 nanometers to 720 nanometers determined from transmission data collected according to ASTM D1003 at a thickness of 1.6 mm; an L* value of 75 to 85; an a* value of −3 to 1; and a b* value of 0 to 5, each determined at a thickness of 1.6 mm determined in accordance with the CIELAB color measurement method. A molded sample of the composition can optionally further exhibit an average percent transmission of 45% to 75% from 400 nanometers to 720 nanometers determined from transmission data collected according to ASTM D1003 at a thickness of 3.2 mm; an L* value of 65 to 75; an a* value of −3 to 1; and a b* value of 0 to 5, each determined at a thickness of 3.2 mm determined in accordance with the CIELAB color measurement method.

In an aspect, the polyetherimide composition can comprise a polyetherimide comprising repeating units derived from meta-phenylene diamine and bisphenol A dianhydride, and the colorant can comprise at least one organic dye, at least one organic pigment, or a combination of at least one organic dye and at least one organic pigment. In an aspect, the composition can comprise an organic violet dye (e.g., Solvent Violet 13) and an organic red dye (e.g., Solvent Red 52). In an aspect, the composition can comprise an organic violet dye (e.g., Solvent Violet 36) and an organic blue pigment (e.g., Pigment Blue 15:4). In an aspect, the composition can comprise an organic blue pigment (e.g., Pigment Blue 15:4). A molded sample of the polyetherimide composition can have a percent transmission of greater than 45%, or greater than 45% to 60% at a wavelength of 450 nanometers according to ASTM D1003 at a thickness of 1.6 millimeters. A molded sample of the polyetherimide composition can have a percent transmission of greater than 50%, or greater than or equal to 55%, or greater than 50% to 65%, or 55% to 65% at a wavelength of 450 nanometers according to ASTM D1003 at a thickness of 1.6 millimeters.

In an aspect, other components not specifically described herein can be excluded from the composition. For example, in an aspect, the composition can minimize or exclude other thermoplastic polymers. For example, thermoplastic polymers other than the polyetherimide can be present in an amount of less than 1 weight percent, or less than 0.1 weight percent, or can be excluded from the composition. In an aspect, the polyetherimide excludes a white colorant or an opacifier. In an aspect, the polyetherimide composition can exclude or minimize white colorants such as metal sulfides (e.g., zinc sulfide) or metal oxides (e.g., titanium dioxide). For example, a white colorant can be present in an amount of less than 1 weight percent, or less than 0.5 weight percent, or less than 0.1 weight percent, or less than 0.01 weight percent, based on the total weight of the composition. In an aspect a weight ratio of a non-white colorant to a white colorant can be 1:0.0001 to 1:0.01, for example 1:0.0001 to 1:0.0005. In an aspect, a white colorant is excluded from the polyetherimide composition.

In an aspect, the composition can optionally further comprise an additive composition, comprising one or more additives selected to achieve a desired property, with the proviso that the additive(s) are also selected so as to not significantly adversely affect a desired property of the composition. For example, any additives present in the composition are selected so as to not significantly adversely affect the transmission and color of the composition. In an aspect, the additive, when present, is miscible with the polyetherimide of the polyetherimide composition. In the present disclosure, an additive is considered “miscible” when the presence of the additive does not increase the haze of a molded sample of the polyetherimide composition by more than 5 percent relative to the haze of a corresponding molded article of the polyetherimide composition not including the additive. Haze can be determined according to ASTM D1003. Exemplary miscible additives can include, for example, phosphite-based stabilizers, mold release agents, materials with refractive indices similar to the polyetherimide at visible wavelengths. The miscibility of a particular additive within the polyetherimide composition can be determined without undue experimentation. In an aspect, additives which are immiscible with the polyetherimide of the polyetherimide composition can be minimized or excluded from the polyetherimide composition. “Immiscible” additives are understood to include those which increase the haze of a molded sample of the polyetherimide composition by more than 5 percent relative to the haze of a corresponding molded article of the polyetherimide composition not including the additive. Such immiscible additives can be present in an amount of not more than 5 weight percent, or not more than 1 weight percent, or not more than 0.1 weight percent, each based on the total weight of the polyetherimide composition. In an aspect, immiscible additives can be excluded from the composition. Exemplary immiscible additives can include, but are not limited to, inorganic materials such as glass fibers, flakes, minerals, graphite, solid pigments such as TiO₂, and the like or a combination thereof.

In an aspect, the polyetherimide can optionally further comprise a polymer different from the polyetherimide having a percent transmission of 72% to 85% at a wavelength of 500 nanometers as determined according to ASTM D1003 at a thickness of 1.6 mm and comprising repeating units derived from bisphenol A dianhydride and an organic diamine, provided that any additional polymers are miscible with the polyetherimide composition. A miscible blend of the polyetherimide and the polymer different from the polyetherimide have sufficient affinity to overcome the unfavorable thermodynamics of mixing and form an intimate mixture where the two polymers are dissolved in one another. The miscible blend can exhibit a single glass transition temperature (Tg), for example by differential scanning calorimetry (DSC). Exemplary miscible polymers can include, but are not limited to, polyester carbonates (e.g., as in U.S. Pat. No. 7,452,944, incorporated by reference herein in its entirety) and polyesters, specifically a poly(C₁₋₆ alkylene terephthalate) (e.g., a poly(ethylene terephthalate), as in U.S. Pat. No. 8,546,516, incorporated by reference herein in its entirety). When present, a polymer different from the polyetherimide can be present in an amount of less than or equal to 50 weight percent, based on the total weight of the polyetherimide composition. Within this range, the polymer different from the polyetherimide can be present in an amount of 1 weight percent to less than or equal to 50 weight percent, or 1 weight percent to less than 50 weight percent, or 5 weight percent to 45 weight percent, or 10 weight percent to 40 weight percent, or 15 weight percent to 35 weight percent, or 5 weight percent to 30 weight percent, or 5 weight percent to 25 weight percent, or 1 weight percent to 25 weight percent, or 1 weight percent to 15 weight percent, or 1 weight percent to 10 weight percent.

The composition can be manufactured by various methods generally known in the art. In an aspect, the polyetherimide can be blended with the colorant, for example in a high-speed mixer or by handmixing. In an aspect, blending the components of the composition can preferably be in the presence of a solvent. Any organic solvent that is capable of solubilizing the components of the composition can be used, for example, ortho-dichlorobenzene, dichloromethane, n-methyl pyrrolidinone, dimethyl or acetamide. The combined components in the solvent can be mixed to disperse the colorant for a suitable time (e.g., 1 hour to 10 hours). The methods for manufacturing the composition are further exemplified in the working examples below.

Colored compositions can be prepared, for example, by melt processing the polyetherimide with one or more colorants after mixing both materials to provide adequate dispersion of colorants. The blend can then be fed into the throat of a twin-screw extruder via a hopper. Alternatively, colors can be compounded into a colorant masterbatch containing higher levels of colorant, and blended with colorant-free polymer pellets in the correct ratio to reach the required colorant loading. The extruder can be generally operated at a temperature higher than that necessary to cause the composition to flow. The extrudate can be immediately quenched in a water bath and pelletized. The pellets so prepared can be one-fourth inch long or less as desired.

The composition can further be formed into an article, preferably an injection molded article. The injection molded article prepared from the polyetherimide composition can advantageously exhibit good transparency. The injection molded article can have a thickness of 0.8 millimeters to 3.2 millimeters.

An injection molded article can exhibit an average percent transmission of 60% to 85%, or 62% to 85% from 400 nanometers to 720 nanometers, determined from transmission data collected according to ASTM D1003 at a thickness of 1.6 mm. In an aspect, the injection molded article can exhibit an average percent transmission of 40% to 85%, or 45% to 85% from 400 nanometers to 720 nanometers determined from transmission data collected according to ASTM D1003 at a thickness of 3.2 mm. In an aspect, the injection molded article can exhibit a percent transmission at 500 nm of 60% to 85% according to ASTM D1003 at a thickness of 1.6 mm. In an aspect, the injection molded article can exhibit a percent transmission at 500 nm of 45% to 85% according to ASTM D1003 at a thickness of 3.2 mm.

In addition to exhibiting good transparency, injection molded articles comprising the polyetherimide composition of the present disclosure can exhibit a particular color while maintaining good transparency. Color of the molded articles can be characterized by the CIELAB color measurement method detailed by CIE (Commission Internationale de l'Eclairage). In this system, L* represents the difference between light (L*=100) and dark (L*=0). The value a represents the difference between green (−a*) and red (+a*), and b* represents the difference between yellow (+b*) and blue (−b*). The value of each parameter represents the magnitude of the difference in color. As described above, targeted color specifications for the compositions and molded articles can be achieved using one or more dyes or pigments, as further exemplified in the working examples below. In an aspect, the targeted color of the articles or compositions can be grey, green, violet, or blue. In an aspect, a molded article comprising the composition can exhibit a CIE L* value of 45 to 85, or 50 to 85, or 50 to 60, or 75 to 85; a CIE a* value of −40 to 60, or −40 to 0, or −40 to −30, or −10 to 10, or −5 to 5, or −20 to 0, or 0 to 20; and a CIE b* value of −10 to 30, or −10 to 10, or −5 to 5, or −5 to 0, or 0 to 5, or 20 to 30, each at a thickness of 1.6 mm. In an aspect, a molded article comprising the composition can exhibit a CIE L* value of 75 to 85; a CIE a* value of −5 to 5; and a CIE b* value of −5 to 5, each at a thickness of 1.6 mm. In an aspect, a molded article comprising the composition can exhibit a CIE L* value of 75 to 85; a CIE a* value of −40 to −30; and a CIE b* value of 20 to 30, each at a thickness of 1.6 mm. In an aspect, a molded article comprising the composition can exhibit a CIE L* value of 50 to 60; a CIE a* value of 0 to 20; and a CIE b* value of 0 to 5, each at a thickness of 1.6 mm. In an aspect, a molded article comprising the composition can exhibit a CIE L* value of 50 to 60; a CIE a* value of −20 to 0; and a CIE b* value of −5 to 0, each at a thickness of 1.6 mm. In an aspect, the injection molded article can exhibit a CIE b* value of −10 to 10, or −5 to 5, or 0 to 5 at a thickness of 1.6 mm or 3.2 mm.

The present inventors have further advantageously discovered that an injection molded article having an average percent transmission of 72% to 85% at 500 nanometers as determined according to ASTM D1003 at a thickness of 1.6 mm can be provided by the above-described polyetherimide. The injection molded article can have a thickness of 0.8 millimeters to 3.2 millimeters. In an aspect, an injection molded article consists essentially of, or consists of the polyetherimide composition, has a thickness of 0.8 millimeters to 3.2 millimeters, and has an average percent transmission of 72% to 85% at 500 nanometers at a thickness of 1.6 mm and an average percent transmission of 65% to 85% at 500 nanometers at a thickness of 3.2 mm as determined according to ASTM D1003.

The injection molded articles described herein can optionally further exhibit one or more of an L* of greater than 90, an a* of −10 to 0, and a b* of 15 to 20.

The injection molded articles of the present disclosure can be particularly useful for applications in healthcare and food packaging. Exemplary articles can be in the form of a fiber, a film, a sheet, a pipe, or a molded part. The physical properties of the composition described herein can provide articles that are particularly well-suited for transparent articles, for example for use in optical applications. Such articles can include optical articles, preferably an optic lens, a lens array, transparent materials applications in medical devices, electronic and telecommunications, building and constructions, sensors, antennas, electrodes, thin film optics, thin film substrates, transistors and IR transparent display devices. In an aspect, the article can be a lens for a single mode optical fiber connector

This disclosure is further illustrated by the following examples, which are non-limiting.

### EXAMPLES

The materials listed in Table 1 were used in the following examples.

TABLE 1

| Component | Description | Supplier |
|---|---|---|
| PEI-1 | Polyetherimide comprising structural units of bisphenol A dianhydride | SABIC |
| | with m-phenylene diamine, phthalic anhydride end capped, with a melt | |
| | volume flow rate of 18 g/10 min, and having a molded yellowness index | |
| | of 75 at 3.2 mm thickness | |
| PEI-2 | Polyetherimide comprising structural units of bisphenol A dianhydride | SABIC |
| | with m-phenylene diamine, phthalic anhydride end capped, with a melt | |
| | volume flow rate of 50 g/10 min, and having a molded yellowness index | |
| | of 92 at 3.2 mm thickness | |
| PEI-3 | Polyetherimide comprising structural units of bisphenol A dianhydride | |
| | made with m-phenylene diamine, phthalic anhydride end capped, with a | |
| | melt volume flow rate of 51 g/10 min, prepared according to Preparative | |
| | Example 1 below | |
| PPSU | Polyphenylene sulfone resin obtained as commercially available as | Solvay |
| | RADEL R5100NT, and having a molded yellowness index of 45 at 3.2 | |
| | mm thickness | |
| BPADA | Bisphenol A dianhydride prepared by hydrolysis ring closure as described | |
| | in WO2020/160215A1 and WO2017/172593 | |
| mPD | Meta-phenylene diamine | AminoChem |
| PA | Phthalic anhydride | Stepan |
| oDCB | Ortho-dichlorobenzene | Achiewell |
| Solvent Violet 13 | Synthetic dye, CAS Registration Number: 81-48-1 | Lanxess |
| Solvent Red 52 | Synthetic dye, CAS Registration Number: 81-39-0 | Lanxess |
| Solvent Violet 36 | Synthetic dye, CAS Registration Number: 61951-89-1 | Clariant |
| Pigment Blue 15:4 | Copper Phthalocyanine Pigment Blue 15:4; CAS Registration Number: | Clariant |
| | 147-14-8 | |

### Preparative Example 1

PEI-3 was prepared according to the following general procedure. BPADA was provided according to the procedures described in International Publication No. 2020/160215. A 120-gallon vessel was charged with the BPADA (34.2 kg, 68.430 mol), mPD (7.4 kg, 68.430 mol), PA (0.811 kg, 5.475 mol), and oDCB (162 kg, 18.8 gal). The system was heated to 75° C. then 125° C. for one hour each under a closed nitrogen atmosphere with agitation. The temperature was increased to 180° C. after 2 hours and concentrated to 35 wt %. After 20 hours, the reaction mixture was extruded at 330° C. to afford a pellet. The resulting polyetherimide (PEI-3) had a melt flow rate of 51 g/10 min and exhibited a yellowness Index of 47 at 3.2 mm thickness.

Colored compositions were prepared by melt processing the polymer with colorants after mixing both materials to provide adequate dispersion of colorants. The blend is then fed into the throat of a twin-screw extruder via a hopper. Alternatively, colors can be compounded into a colorant masterbatch containing higher levels of colorant, and blended with colorant-free polymer pellets in the correct ratio to reach the required colorant loading. The extruder is generally operated at a temperature higher than that necessary to cause the composition to flow. The extrudate can be immediately quenched in a water bath and pelletized. The pellets so prepared can be one-fourth inch long or less as desired.

Dried pellets of the compositions of the following examples were molded into color plaques using a 120 ton Demag injection molding machine according to the injection molding profile shown in Table 2.

TABLE 2

| Profile Parameters | Units | |
|---|---|---|
| Pre-drying temp | ° F. | 300 |
| Pre-drying time | hr | 6 |
| Zone 1 Temperature | | N/A |
| (Feed) | | |
| Zone 2 Temperature | ° F. | 660-700 |
| (Rear, BZ1) | | |
| Zone 3 Temperature | ° F. | 660-700 |
| (Center, BZ2) | | |
| Zone 4 Temperature | ° F. | 660-700 |
| (Front, BZ3) | | |
| Nozzle temp | ° F. | 660-700 |
| (Nozzle) | | |
| Mold temp | ° F. | 300 |
| Screw speed | rpm | 60 |
| Back pressure | psi | 50 |
| Decompression | in | 0 |
| Cycle time | s | 34.61 |

Molded color plaques were molded as a 37.5×50×1.0 mm plaque or as a 75×50 mm step plaque with two halves at 1.6 mm or 3.2 mm thickness. Average transmission, total transmittance, and color measurements were tested in accordance with ASTM D1003 using an X-Rite Ci7800 spectrophotometer in ILLC/2° with a 10 nm resolution. Data from 1.0 mm and 1.6 mm thicknesses are reported here. Yellowness index is calculated based on the ASTM E313 (2015) standard for the reported thickness as part of the transmission and color measurement. A standard C illuminant is analogous to a daylight simulation.

Total transmittance in ASTM D1003 is weighted to the spectral luminous efficiency function V(λ) of the CIE (1987). This photopic efficiency function has a shape similar to a Gaussian function with a peak at 555 nm. Blue and red wavelengths are underweighted in this transmission calculation. A material with high transparency near 555 nm and low transparency at either red or blue wavelengths will have a higher total transmittance than otherwise indicated. A percent transmission average was also calculated by an unweighted numeric average of the reported transmission values from 400 nm to 720 nm at 10 nm intervals.

Color analysis was conducted using the CIE L* a* b* color system, with color measurements made according to ASTM E308-15. The reported values are a set of three separate measurements. a* represents the color of the resin on a green (−) to red (+) scale, while b* represents color on a blue (−) to yellow (+) scale. For example, a positive a* (red) combined with a negative b* (blue) will appear to have a purple hue under the illumination standard light source. L* represents the dark (0) to light (100) color of the material. In general, the addition of pigments will shift a* and b*, but L* is reduced as the pigments absorb more light. Targeted color specifications are typically achieved by using one or more dyes or pigments.

Plaques were measured at thicknesses of 1.6 mm and 3.2 mm for L* a* b* and % T average (400 nm to 720 nm). These results are shown in Table 3.

TABLE 3

| | | CE1 | CE2 | E1 | CE3 |
|---|---|---|---|---|---|
| Polymer | Units | PEI-1 | PEI-2 | PEI-3 | PPSU |
| % T at 400 nm, 1.6 mm | % | 0.3 | 0.4 | 0.8 | 31 |
| % T at 450 nm, 1.6 mm | % | 40.2 | 28.8 | 63.8 | 61.4 |
| % T at 500 nm, 1.6 mm | % | 67.3 | 56.1 | 77.8 | 72.4 |
| % T at 550 nm, 1.6 mm | % | 76.8 | 68.7 | 82.8 | 78.5 |
| % T at 600 nm, 1.6 mm | % | 81.6 | 77.2 | 85.5 | 81.9 |
| % T at 700 nm, 1.6 mm | % | 85.7 | 83.1 | 87.0 | 82.2 |
| L*, 1.6 mm | | 89.9 | 86.1 | 92.7 | 90.9 |
| a*, 1.6 mm | | −8.2 | −6.4 | −5.7 | −2.6 |
| b*, 1.6 mm | | 33.5 | 40.8 | 17.9 | 14.4 |
| % T Average, | % | 67.8 | 61.7 | 74.7 | 72.8 |
| 400 to 720 nm, 1.6 mm | | | | | |
| % T at 400 nm, 3.2 mm | % | 0.1 | 0.1 | 0.3 | 10.6 |
| % T at 450 nm, 3.2 mm | % | 19 | 9.9 | 47.3 | 43.1 |
| % T at 500 nm, 3.2 mm | % | 67.2 | 36.2 | 69.3 | 59.8 |
| % T at 550 nm, 3.2 mm | % | 67 | 53.8 | 78.1 | 70.5 |
| % T at 600 nm, 3.2 mm | % | 76.8 | 65.8 | 82.4 | 76.5 |
| % T at 700 nm, 3.2 mm | % | 83.1 | 78.3 | 85.7 | 82.2 |
| L*, 3.2 mm | | 85.1 | 78.4 | 90.5 | 87.1 |
| a*, 3.2 mm | | −7.3 | −1.9 | −7.5 | −3.3 |
| b*, 3.2 mm | | 51.8 | 59.8 | 29 | 26.0 |
| Transmittance | | 68.5 | 55.8 | 80 | 71 |
| (Tₜ, 3.2 mm) | | | | | |
| Transmittance | | 78 | 69 | 84 | 79 |
| (Tₜ, 1.6 mm) | | | | | |
| % T Average, | % | 59.33 | 50.9 | 67.8 | 63.4 |
| 400 to 720 nm, 3.2 mm | | | | | |
| Haze, 3.2 mm | % | 1.5 | 1.6 | 1.8 | 3.3 |

As shown in Table 3, PEI-3 of E1 exhibits an average percent transmission that is higher at all wavelengths tested compared to CE1 and CE2 at both 1.6 mm and 3.2 mm thicknesses. These values can exceed the values of other high temperature amorphous thermoplastics for wavelengths higher than 500 nm. Percent transmission at 500 nm for 1.6 mm of greater than 75% would not be possible through current comparative polyetherimide examples or polyphenylene sulfone of CE3. At 450 nm, 60% transmission at 1.6 mm is achievable in the polyetherimide of E1. At higher wavelengths, such as 700 nm, comparative PEI samples can be at or near equivalent transmission to E1. CE3, with a yellowness index 30 points lower, is less transparent than CE1 for points between 500 nm and 700 nm.

Colored compositions having a transparent grey color were also prepared. Colored compositions targeted transparent color families of green, blue, grey, or violet. Pellets were prepared using a twin-screw, vacuum vented, 32 mm Werner Pfleiderer twin screw extruder with six temperature barrel sections. Extrusion was performed at a barrel temperatures starting at 338° C. (640° F.) and incrementing to reach 360° C. (680° F.) at zone 6. The reported die temperature was 371° C. (700° F.), screw speed of 200 rpm, and output of 9.1 kilograms per hour (kg/h). Extrusion was run with vacuum venting. The screw design included enough distributive and dispersive mixing elements to produce good mixing and consistent pellet color by visual appearance. The melt processed compositions exited the extruder through small exit holes in a die. The resulting strands of molten resin were cooled by passing the strands through a water bath.

Comparative compositions are shown in Table 4.

TABLE 4

| Name | Units | CE4 | CE5 | CE6 | CE7 |
|---|---|---|---|---|---|
| PEI-1 | wt % | 99.98148 | 99.99198 | 99.983944 | 99.994444 |
| Solvent Violet 13 | wt % | 0.015 | 0.0045 | 0.015 | 0.0045 |
| Solvent Red 52 | wt % | 0.00352 | 0.00352 | 0.001056 | 0.001056 |
| Color Target | | Transparent Grey | | | |
| L*, 1.0 mm | | 61.964 | 74.912 | 62.674 | 77.05 |
| a*, 1.0 mm | | 7.378 | 4.278 | 1.77 | −1.878 |
| b*, 1.0 mm | | −4.73 | 14.266 | −4.42 | 14.66 |
| Transmittance | % | 31 | 49.3 | 32 | 53.1 |
| (Tₜ, 1.0 mm) | | | | | |
| % T Average, | % | 40.4 | 51.3 | 40.4 | 52.9 |
| 400 to 720 nm, | | | | | |
| 1.0 mm | | | | | |

As shown in Table 4, obtaining an optimized grey formulation requires a* and b* close to zero while maintaining a high L* value. As demonstrated by CE4-CE7, this is difficult to achieve. Higher loading levels of the dyes reduce L* and the average transparency. Average percent transmission in all formulations in the comparative examples could only reach a maximum percent transmission of 53% at 1.0 mm thickness. These resins were not neutral grey tone, but instead exhibited a weak tan or purple coloration. Table 5 shows the use of the same two dyes from Table 4 to provide transparent grey compositions using PEI-1, PEI-3 and PPSU.

TABLE 5

| Name | Units | E2 | CE8 | CE9 | CE10 | CE11 |
|---|---|---|---|---|---|---|
| PEI-3 | wt % | 99.9964 | | | | |
| PEI-1 | wt % | | 99.9946 | 99.9865 | | |
| PPSU | wt % | | | | 100 | 99.9964 |
| Solvent Violet 13 | wt % | 0.006 | 0.006 | 0.009 | 0 | 0.006 |
| Solvent Red 52 | wt % | 0.003 | 0.003 | 0.0045 | 0 | 0.003 |
| Color Target | | T. Grey | T. Grey | T. Grey | Natural | T. Grey |
| Visual Color Appearance | | Grey with | Purple/blue | Purple/blue | Yellow | Grey with |
| | | purple tint | | | | purple tint |
| L*, 1.6 mm | | 81 | 77.5 | 72.2 | 87.1 | 79.1 |
| a*, 1.6 mm | | −1.0 | −4.4 | −3.0 | −2.6 | 2.6 |
| b*, 1.6 mm | | 3.8 | 24.5 | 21.5 | 14.4 | 3.5 |
| % T Average, 400 to 720 nm, 1.6 mm | % | 62.3 | 51.9 | 46.9 | 72.8 | 59.2 |
| % T at 450 nm, 1.6 mm | % | 58.8 | 31.6 | 26.7 | 61.4 | 52.4 |
| % T at 500 nm, 1.6 mm | % | 64.6 | 51.8 | 46.0 | 72.4 | 57 |
| L*, 3.2 mm | | 69.1 | 63.5 | 54.9 | 85.1 | 65.8 |
| a*, 3.2 mm | | 0.5 | −0.6 | 2.1 | −3.3 | 5.6 |
| b*, 3.2 mm | | 3.1 | 32.1 | 25.8 | 26.0 | 5.4 |
| % T Average, 400 to 720 nm, 3.2 mm | % | 49 | 37.8 | 32.1 | 63.3 | 43.4 |
| % T at 450 nm, 3.2 mm | % | 40.2 | 12.2 | 8.8 | 43.1 | 32.2 |
| % T at 500 nm, 3.2 mm | % | 47.7 | 31.4 | 24.6 | 59.8 | 37.7 |
| Haze, 3.2 mm | % | 3.5 | | | | |

It can be seen that the desired transparent grey color cannot be achieved for compositions based on PEI-1 or PPSU. For compositions including PEI-1, the necessary b* cannot be achieved as the high initial b* value of the base resin (i.e., PEI-1 itself) would require a significantly larger quantity of dyes to mask the yellow color. Modifications to the CEB formulation of Table 5 to reduce b*, such as in CE9, would further undesirably decrease the transparency. Using PPSU, the initial average transparency as measured in CE4. is close to that of E2. Attempts to match to a neutral color in CE4. reduced average transparency below 45% at 1.6 mm. The selection of a PPSU with a similar yellowness index does not allow for an equivalent color space gamut with a high overall percent transmission, even though the yellowness index measurement would indicate the color capability is similar to PEI-3.

Colored compositions having a transparent green, violet/red or blue color were also prepared. Results are provided in Table 6.

TABLE 6

| Name | Units | CE12 | CE13 | E3 | CE14 | E4 | CE15 | E5 | E6 |
|---|---|---|---|---|---|---|---|---|---|
| PEI-1 | wt % | 99.995 | | | 99.99 | | 99.985 | | |
| PEI-3 | wt % | | | 99.9975 | | 99.99 | | 99.985 | 99.9925 |
| PPSU | wt % | | 99.9975 | | | | | | |
| Solvent Violet 36 | wt % | 0 | 0 | 0 | 0.01 | 0.01 | 0.01 | 0.01 | 0.005 |
| Pigment Blue 15:4 | wt % | 0.005 | 0.0025 | 0.0025 | 0 | 0 | 0.005 | 0.005 | 0.0025 |
| Color Target | | Green | Green | Green | Violet | Violet | Blue | Blue | Blue |
| L*, 1.6 mm | | 79.1 | 84.6 | 87.1 | 56.1 | 62.7 | 53.2 | 53.9 | 69.7 |
| a*, 1.6 mm | | −34.9 | −18.6 | −20.2 | 17.5 | 18.9 | −11.7 | −2.5 | −2.1 |
| b*, 1.6 mm | | 24.1 | 10.1 | 13.0 | 2.3 | −8.7 | −4.3 | −22.7 | −6 |
| Transmittance (Tₜ, 1.6 mm) | | 57.2 | 67.3 | 72.4 | 24.5 | 31.7 | 22.3 | | 41.3 |
| % T Average, 400 to 720 nm, 1.6 mm | % | 37.8 | 52.7 | 54 | 36 | 43.7 | 21.1 | 28.2 | 40.7 |
| % T at 450 nm, 1.6 mm | % | 32.7 | 54.2 | 58.3 | 24.5 | 42.0 | 25 | 41.4 | 47 |
| % T at 500 nm, 1.6 mm | % | 59.3 | 67.2 | 73.4 | 27.4 | 36.3 | 30.6 | 34.2 | 47.1 |
| % T at 550 nm, 1.6 mm | % | 64.9 | 71.9 | 76.6 | 17.8 | 24.2 | 20.4 | 20.1 | 39.2 |
| L*, 3.2 mm | | 67.8 | 75.7 | 80.2 | 34.6 | 41.9 | 29.5 | 29.5 | 50.4 |
| a*, 3.2 mm | | −48.2 | −30.5 | −32.5 | 29.4 | 31.5 | −12.8 | 2.4 | −2.4 |
| b*, 3.2 mm | | 33.5 | 18.2 | 20.3 | 4.0 | −11.7 | −7.4 | −30.8 | −9.7 |
| % T Average, 400 to 720 nm, 3.2 mm | % | 51.3 | 35.8 | 40 | 22.1 | 28.3 | 8.1 | 9.8 | 21.2 |
| % T at 450 nm, 3.2 mm | % | 14 | 33.3 | 39.2 | 7.6 | 20.6 | 8 | 19.9 | 25.3 |
| % T at 500 nm, 3.2 mm | % | 43.1 | 51.4 | 61.2 | 9.3 | 15.3 | 11.6 | 13.4 | 25.3 |
| % T at 550 nm, 3.2 mm | % | 49.1 | 58.8 | 66.6 | 4.1 | 6.8 | 5.3 | 4.6 | 17.5 |
| Haze, 3.2 mm | % | 5.6 | 4.5 | 3.5 | 4.8 | 4.6 | 4.8 | 3.6 | 4.0 |

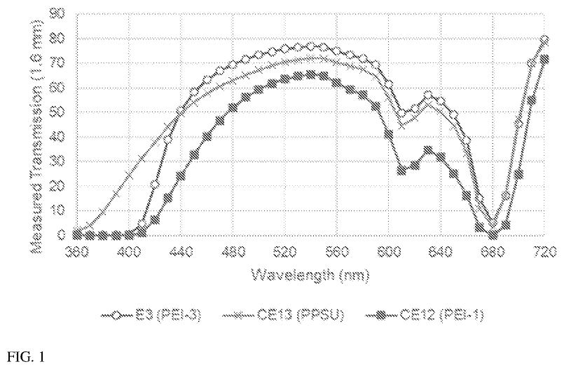

The transmission at 1.6 millimeters for the compositions of example 3 and comparative examples 12 and 13 is also shown in FIG. 1. From FIG. 1, it can be seen that the transmission of the composition of E3 exceeds the transmission of both CE12 and CE13 from a wavelength of 440 nanometers to 660 nanometers.

Higher percent transmission in the base resin allows for the increased transparency and color options. This effect should only be observed when thickness and colorant levels allow for high transmission between 450 nm to 550 nm. Higher levels of the blue and violet dyes will make a dark transparent violet color. Table 7 shows samples which include 10 to 20 times the dye loading of the samples of Table 6 to make deep violet compositions comprising PEI-3 or PPSU. CE16 does not provide an increased transmission at the measured thicknesses, because the two colorants absorb all available light transmission.

TABLE 7

| Name | Units | CE16 | CE17 |
|---|---|---|---|
| PEI-3 | wt % | 99.895 | |
| PPSU | wt % | | 99.895 |
| SV36 | wt % | 0.1 | 0.1 |
| PB15:4 | wt % | 0.005 | 0.005 |
| Color Target | | Deep Violet | Deep Violet |
| Visual Color Appearance | | Deep Violet | Deep Violet |
| L*, 1.6 mm | | 2.5 | 2.9 |
| a*, 1.6 mm | | 39.0 | 45.9 |
| b*, 1.6 mm | | −36.6 | −41.5 |
| % T at 400 nm, 1.6 mm | | 0.09 | 8 |
| % T at 450 nm, 1.6 mm | | 4.8 | 5 |
| % T at 500 nm, 1.6 mm | | 0.1 | 0.2 |
| % T at 550 nm, 1.6 mm | | 0.1 | 0.1 |

This disclosure further encompasses the following aspects.
Aspect 1: A polyetherimide composition comprising: a polyetherimide having a percent transmission of 72% to 85% at a wavelength of 500 nanometers as determined according to ASTM D1003 at a thickness of 1.6 mm and comprising repeating units derived from bisphenol A dianhydride and an organic diamine; and a colorant; wherein a molded sample of the polyetherimide composition has a percent transmission of greater than 40% at a wavelength of 450 nanometers according to ASTM D1003 at a thickness of 1.6 millimeters; and a percent transmission of greater than 15% at a wavelength of 450 nanometers according to ASTM D1003 at a thickness of 3.2 millimeters.
Aspect 2: The polyetherimide composition of aspect 1, wherein the polyetherimide comprises repeating units of the formula

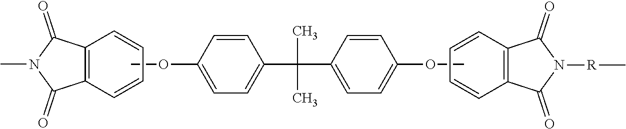

wherein R is a divalent group of the formula

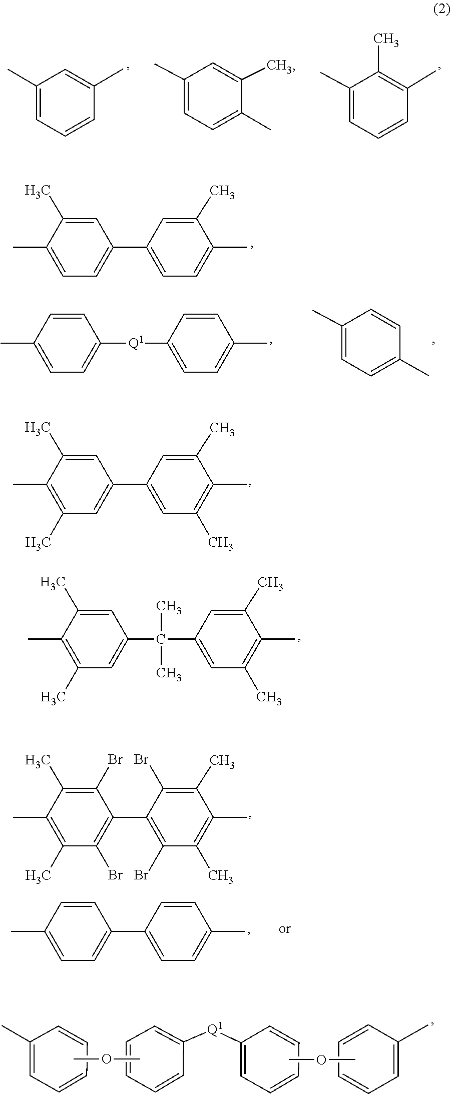

wherein Q¹ is —O—, —S—, —C(O)—, —SO₂—, —SO—, —P(R^{a})(═O)— wherein R^{a} is a C₁₋₈ alkyl or C₆₋₁₂ aryl, —C_{y}H_{2y}— wherein y is an integer from 1 to 5 or a halogenated derivative thereof, or —(C₆H₁₀)_{z} wherein z is an integer from 1 to 4; preferably wherein R comprises m-phenylene diamine; preferably wherein the divalent bonds of the bisphenol A group are in the 4,4′ positions.
Aspect 3: The polyetherimide composition of aspects 1 or 2, wherein a molded sample of the polyetherimide composition has an average percent transmission of 25% to 85%, or 40% to 85%, or 60% to 85% from 400 nanometers to 720 nanometers according to ASTM D1003 at a thickness of 1.6 mm.
Aspect 4: The polyetherimide composition of any of aspects 1 to 3, wherein a molded sample of the polyetherimide composition has an average percent transmission of 70% to 85% from 400 nanometers to 720 nanometers determined from transmission data collected according to ASTM D1003 at a thickness of 1.6 mm.
Aspect 5: The polyetherimide composition of any of aspects 1 to 4, wherein a molded sample of the polyetherimide composition has a percent transmission of greater than 45%, or greater than 45% to 60% at a wavelength of 450 nanometers according to ASTM D1003 at a thickness of 1.6 millimeters.
Aspect 6: The polyetherimide composition of any of aspects 1 to 5, wherein a molded sample of the polyetherimide composition has a percent transmission of greater than 50%, or greater than or equal to 55%, or greater than 50% to 65%, or 55% to 65% at a wavelength of 450 nanometers according to ASTM D1003 at a thickness of 1.6 millimeters; and a percent transmission of greater than 55%, or greater than or equal to 60%, or greater than 55% to 80%, or 60% to 75% at a wavelength of 500 nanometers according to ASTM D1003 at a thickness of 1.6 millimeters.
Aspect 7: The polyetherimide composition of any of aspects 1 to 6, wherein a molded sample of the polyetherimide composition has a b* value of −10 to 10 at a thickness of 1.6 mm, determined in accordance with the CIELAB color measurement method.
Aspect 8: The polyetherimide composition of any of aspects 1 to 7, wherein the colorant is a non-white colorant.
Aspect 9: The polyetherimide composition of any of aspects 1 to 8, wherein the colorant is soluble in the polyetherimide.
Aspect 10: The polyetherimide composition of any of aspects 1 to 9, wherein the colorant is not an inorganic pigment.
Aspect 11: The polyetherimide composition of aspect 1, wherein the polyetherimide comprises repeating units of the formula

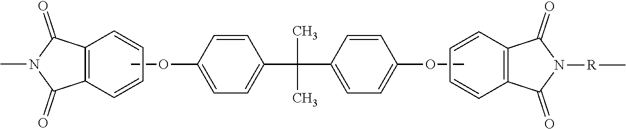

wherein at least 50% of the R groups are derived from meta-phenylene diamine; the colorant comprises at least two solvent dyes, at least two pigments, or a combination of at least one solvent dye and at least one pigment; and a molded sample of the polyetherimide composition exhibits: an average percent transmission of 60% to 75% from 400 nanometers to 720 nanometers determined from transmission data collected according to ASTM D1003 at a thickness of 1.6 mm; an L* value of 75 to 85; an a* value of −3 to 1; and a b* value of 0 to 5, each determined in accordance with the CIELAB color measurement method.
Aspect 12: The polyetherimide composition of any of aspects 1 to 11, comprising 0.0005 weight percent to 0.05 weight percent, or 0.0005 to 0.01 weight percent of the colorant, wherein weight percent is based on the total weight of the polyetherimide composition.
Aspect 13: The polyetherimide composition of any of aspects 1 to 12, comprising 99.99 weight percent to 99.9985 weight percent of the polyetherimide; and 0.0015 weight percent to 0.01 weight percent of the colorant; wherein weight percent is based on the total weight of the composition.
Aspect 14: The polyetherimide composition of any of aspects 1 to 13, wherein the polyetherimide is free of fluorine substituents; or the polyetherimide composition is free of UV stabilizers; or the polyetherimide is free of fluorine substituents and the polyetherimide composition is free of UV stabilizers.
Aspect 15: An injection molded article comprising the polyetherimide composition of any of aspects 1 to 14, wherein the injection molded article has a percent transmission of greater than 40% at a wavelength of 450 nanometers according to ASTM D1003 at a thickness of 1.6 millimeters; and a percent transmission of greater than 15% at a wavelength of 450 nanometers according to ASTM D1003 at a thickness of 3.2 millimeters; preferably, wherein the injection molded article has a thickness of 0.8 to 3.2 mm; and preferably, wherein the injection molded article comprises: a polyetherimide comprising repeating units of the formula

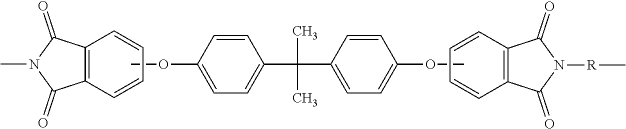

wherein R is a divalent group of the formula

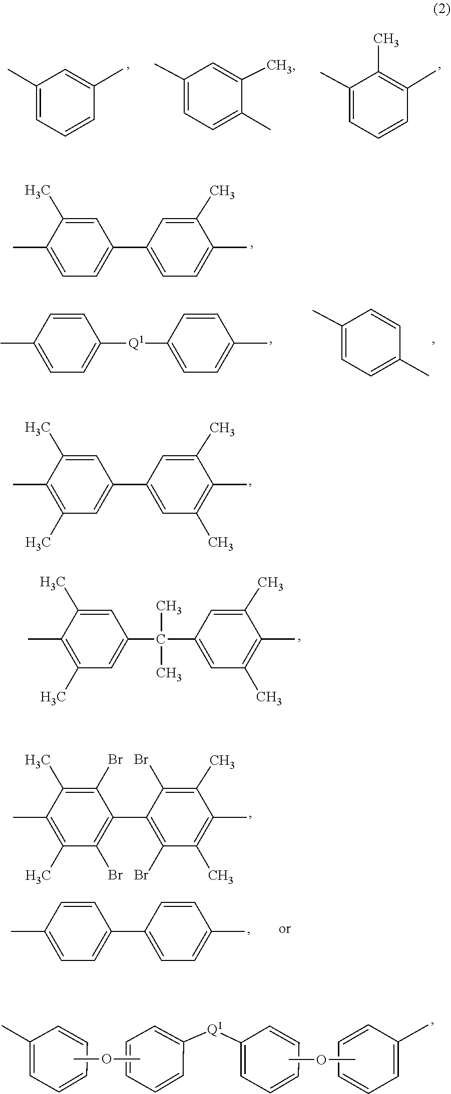

wherein Q¹ is —O—, —S—, —C(O)—, —SO₂—, —SO—, —P(R^{a})(═O)— wherein R^{a} is a C₁₋₈ alkyl or C₆₋₁₂ aryl, —C_{y}H_{2y}— wherein y is an integer from 1 to 5 or a halogenated derivative thereof, or —(C₆H₁₀)_{z} wherein z is an integer from 1 to 4; preferably wherein R comprises meta-phenylene diamine and the divalent bonds of the bisphenol A group are in the 4,4′ positions.
Aspect 16: A method of making an injection molded article, the method comprising: injection molding a polyetherimide composition, the composition comprising: a polyetherimide having a percent transmission of 72% to 85% at 500 nanometers as determined according to ASTM D1003 at a thickness of 1.6 mm and comprising repeating units derived from bisphenol A dianhydride and an organic diamine; and optionally, a colorant; wherein the injection molded article has a percent transmission of greater than 40% at a wavelength of 450 nanometers according to ASTM D1003 at a thickness of 1.6 millimeters; and a percent transmission of greater than 15% at a wavelength of 450 nanometers according to ASTM D1003 at a thickness of 3.2 millimeters.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “an aspect” means that a particular element described in connection with the aspect is included in at least one aspect described herein, and may or may not be present in other aspects. The term “combination thereof” as used herein includes one or more of the listed elements, and is open, allowing the presence of one or more like elements not named. In addition, it is to be understood that the described elements may be combined in any suitable manner in the various aspects.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

As used herein, the term “hydrocarbyl”, whether used by itself, or as a prefix, suffix, or fragment of another term, refers to a residue that contains only carbon and hydrogen. The residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. However, when the hydrocarbyl residue is described as substituted, it may, optionally, contain heteroatoms over and above the carbon and hydrogen members of the substituent residue. Thus, when specifically described as substituted, the hydrocarbyl residue can also contain one or more carbonyl groups, amino groups, hydroxyl groups, or the like, or it can contain heteroatoms within the backbone of the hydrocarbyl residue. The term “alkyl” means a branched or straight chain, saturated aliphatic hydrocarbon group, e.g., methyl, ethyl, n-propyl, i-propyl, n-butyl, s-butyl, t-butyl, n-pentyl, s-pentyl, and n- and s-hexyl. “Alkenyl” means a straight or branched chain, monovalent hydrocarbon group having at least one carbon-carbon double bond (e.g., ethenyl (—HC═CH₂)). “Alkoxy” means an alkyl group that is linked via an oxygen (i.e., alkyl-O—), for example methoxy, ethoxy, and sec-butyloxy groups. “Alkylene” means a straight or branched chain, saturated, divalent aliphatic hydrocarbon group (e.g., methylene (—CH₂—) or, propylene (—(CH₂)₃—)). “Cycloalkylene” means a divalent cyclic alkylene group, —CₙH₂ₙ₋ₓ, wherein x is the number of hydrogens replaced by cyclization(s). “Cycloalkenyl” means a monovalent group having one or more rings and one or more carbon-carbon double bonds in the ring, wherein all ring members are carbon (e.g., cyclopentyl and cyclohexyl). “Aryl” means an aromatic hydrocarbon group containing the specified number of carbon atoms, such as phenyl, tropone, indanyl, or naphthyl. “Arylene” means a divalent aryl group. “Alkylarylene” means an arylene group substituted with an alkyl group. “Arylalkylene” means an alkylene group substituted with an aryl group (e.g., benzyl). The prefix “halo” means a group or compound including one more of a fluoro, chloro, bromo, or iodo substituent. A combination of different halo atoms (e.g., bromo and fluoro), or only chloro atoms can be present. The prefix “hetero” means that the compound or group includes at least one ring member that is a heteroatom (e.g., 1, 2, or 3 heteroatom(s)), wherein the heteroatom(s) is each independently N, O, S, Si, or P. “Substituted” means that the compound or group is substituted with at least one (e.g., 1, 2, 3, or 4) substituents that can each independently be a C₁₋₉ alkoxy, a C₁₋₉ haloalkoxy, a nitro (—NO₂), a cyano (—CN), a C₁₋₆ alkyl sulfonyl (—S(═O)₂-alkyl), a C₆₋₁₂ aryl sulfonyl (—S(═O)₂-aryl), a thiol (—SH), a thiocyano (—SCN), a tosyl(CH₃C₆H₄SO₂—), a C₃₋₁₂ cycloalkyl, a C₂₋₁₂ alkenyl, a C₅₋₁₂ cycloalkenyl, a C₆₋₁₂ aryl, a C₇₋₁₃ arylalkylene, a C₄₋₁₂ heterocycloalkyl, and a C₃₋₁₂ heteroaryl instead of hydrogen, provided that the substituted atom's normal valence is not exceeded. The number of carbon atoms indicated in a group is exclusive of any substituents. For example —CH₂CH₂CN is a C₂ alkyl group substituted with a nitrile.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A polyetherimide composition comprising:
a polyetherimide having a percent transmission of 72% to 85% at a wavelength of 500 nanometers as determined according to ASTM DI 003 at a thickness of 1.6 mm and comprising repeating units derived from bisphenol A dianhydride and an organic diamine; and
a colorant;
wherein a molded sample of the poly etherimide composition has
a percent transmission of greater than 40% at a wavelength of 450 nanometers according to ASTM D1003 at a thickness of 1.6 millimeters; and
a percent transmission of greater than 15% at a wavelength of 450 nanometers according to ASTM D1003 at a thickness of 3.2 millimeters.

2. The poly etherimide composition of claim 1, wherein the polyetherimide comprises repeating units of the formula 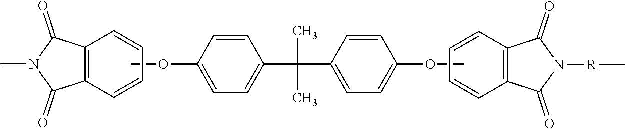
wherein R is a divalent group of the formula 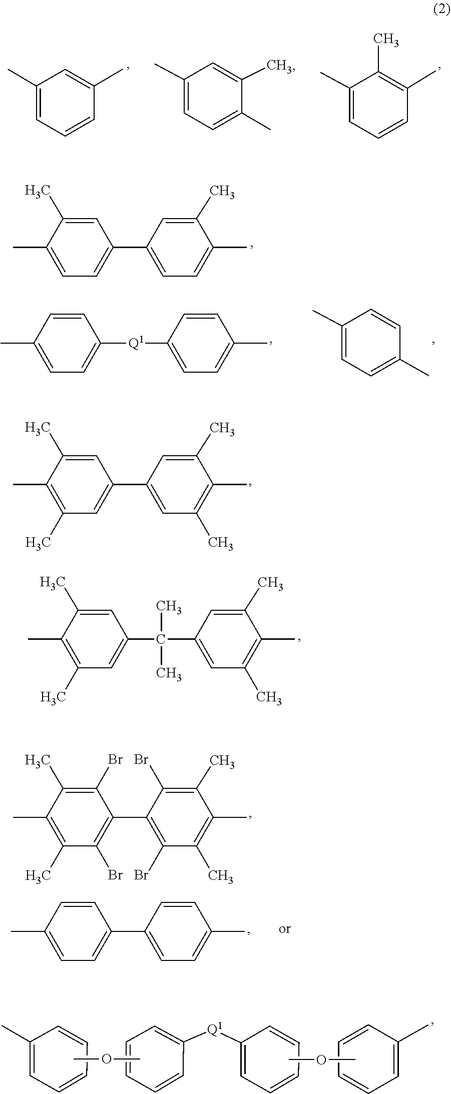
wherein Q¹ is —O—, —S—, —C(O)—, —SO₂—, —SO—, —P(R^{a})(═O)— wherein R^{a} is a C₁₋₈ alkyl or C₆₋₁₂ aryl, —C_{y}H_{2y}— wherein y is an integer from 1 to 5 or a halogenated derivative thereof, or —(C₆H₁₀)_{z}— wherein z is an integer from 1 to 4.

3. The poly etherimide composition of claim 1, wherein a molded sample of the polyetherimide composition has an average percent transmission of 25% to 85%; from 400 nanometers to 720 nanometers determined from transmission data collected according to ASTM DI 003 at a thickness of 1.6 mm.

4. The poly etherimide composition of claim 1, wherein a molded sample of the polyetherimide composition has an average percent transmission of 70% to 85% from 400 nanometers to 720 nanometers determined from transmission data collected according to ASTM D1003 at a thickness of 1.6 mm.

5. The poly etherimide composition of claim 1, wherein a molded sample of the poly etherimide composition has a percent transmission of greater than 45%, at a wavelength of 450 nanometers according to ASTM DI 003 at a thickness of 1.6 millimeters.

6. The polyetherimide composition of claim 1, wherein a molded sample of the polyetherimide composition has
a percent transmission of greater than 50% at a wavelength of 450 nanometers according to ASTM D1003 at a thickness of 1.6 millimeters; and
a percent transmission of greater than 55% a wavelength of 500 nanometers according to ASTM D1003 at a thickness of 1.6 millimeters.

7. The polyetherimide composition of claim 1, wherein a molded sample of the poly etherimide composition has a b* value of −10 to 10 at a thickness of 1.6 mm, determined in accordance with the CIELAB color measurement method.

8. The poly etherimide composition of claim 1, wherein the colorant is a nonwhite colorant.

9. The poly etherimide composition of claim 1, wherein the colorant is soluble in the polyetherimide.

10. The polyetherimide composition of claim 1, wherein the colorant is not an inorganic pigment.

11. The poly etherimide composition of claim 1, wherein the polyetherimide comprises repeating units of the formula 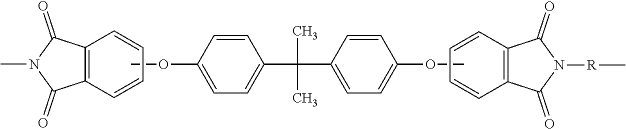
wherein at least 50% of the R groups are derived from meta-phenylene diamine;
the colorant comprises at least two solvent dyes, at least two pigments, or a combination of at least one solvent dye and at least one pigment; and
a molded sample of the polyetherimide composition exhibits:
an average percent transmission of 60% to 75% from 400 nanometers to 720 nanometers determined from transmission data collected according to ASTM DI 003 at a thickness of 1.6 mm;
an L* value of 75 to 85;
an a* value of −3 to 1; and
a b* value of 0 to 5,
each determined in accordance with the CIELAB color measurement method.

12. The poly etherimide composition of claim 1, comprising 0.0005 weight percent to 0.05 weight percent of the colorant, wherein weight percent is based on the total weight of the polyetherimide composition.

13. The poly etherimide composition of claim 1, comprising
99.98 weight percent to 99.9985 weight percent of the polyetherimide; and
0.0015 weight percent to 0.02 weight percent of the colorant;
wherein weight percent is based on the total weight of the composition.

14. The poly etherimide composition of claim 1, wherein
the poly etherimide is free of fluorine substituents; or
the poly etherimide composition is free of UV stabilizers; or
the polyetherimide is free of fluorine substituents and the polyetherimide composition is free of UV stabilizers.

15. An injection molded article comprising the poly etherimide composition of claim 1, wherein the injection molded article has
a percent transmission of greater than 40% at a wavelength of 450 nanometers according to ASTM DI 003 at a thickness of 1.6 millimeters; and
a percent transmission of greater than 15% at a wavelength of 450 nanometers according to ASTM D1003 at a thickness of 3.2 millimeters;
preferably, wherein the injection molded article has a thickness of 0.8 to 3.2 mm; and
preferably, wherein the injection molded article comprises:
a polyetherimide comprising repeating units of the formula 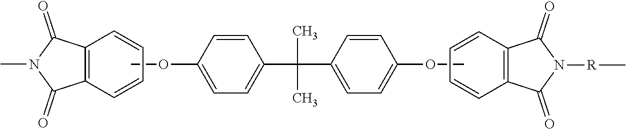
wherein R is a divalent group of the formula 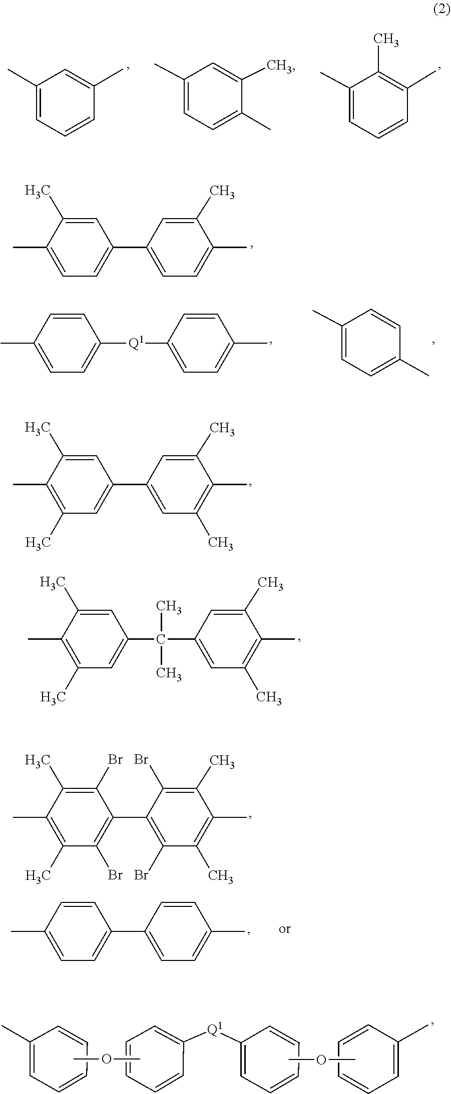
wherein Q¹ is —O—, —S—, —C(O)—, —SO₂—, —SO—, —P(R^{a})(═O)— wherein R^{a} is a C₁₋₈ alkyl or C₆₋₁₂ aryl, —C_{y}H_{2y}— wherein y is an integer from 1 to 5 or a halogenated derivative thereof, or −(C₆H₁₀)_{z}— wherein z is an integer from 1 to 4.
